(19) United States
(12) Patent Application Publication
(10) Pub. No.: US 2008/0159806 A1
(43) Pub. Date: Jul. 3, 2008

(54) Corner joint assembly for silk screen frames

(76) Inventor: John Niswonger, Calabasas, CA (US)

Correspondence Address: EDWIN TARVER, 16830 Ventura Blvd., SUITE 360, Encino, CA, 91436, US

(21) Appl. No.: 11/648,093

(22) Filed: Dec. 29, 2006

(51) Int. Cl. B25G 3/00

(52) U.S. Cl. 403/231

(57) ABSTRACT

A corner joint assembly comprising a male member and a female member for constructing silk screen frames. The male member comprises a silk screen frame member connector, a block with at least one hole extending through the rectangular block. The female member comprises a silk screen frame member connector, two opposing slots, and at least one hole extending through the member between the slots. The connectors are securely and hermetically connected to the frame members. The block of the male member is received inside a slot of the female member, a bolt passing through the holes in the male and female members. The head of the bolt rests against the male member and a portion of the shank of the bolt projects from the second slot of the female member for receiving a nut.

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to corner joints, and more particularly to a corner joint assembly used for constructing a silk screen frame.

Structural frames are made by assembling a plurality so that rigid corners are created between the frame side members. The ends of the side members are usually permanently connected. Corner joint devices can be used to construct temporary connections, facilitating assembly and disassembly of a frame.

Several types of corner joint devices have been developed in art. For example, U.S. Pat. No. 6,089,778 to Hirano discloses a joint for connecting two resin-coated steel pipes in an intersecting fashion. The joint comprises two cylindrical tubes of equal length that are connected into L-shaped configuration via a curved connecting portion. The resin-coated steel pipes are inserted into the cylindrical tubes. The joint also includes slits for permitting a pair of fitting ribs of the resin-coated steel pipes to project there through and cover ribs extending along both sides of the entire length of the slits for covering outer side surfaces of the pair of fitting ribs of the resin-coated steel pipe.

U.S. Pat. No. 5,820,289 to Kern discloses a corner joint device for longitudinal bars and cross bars that are created from hollow profiles. The device has three legs connected at right angles to each other by a connecting block. The connecting block is a short elbow onto which two of the three legs are formed. The third leg is connected in a removable manner to the crest of the connecting block. The hollow profiles of the bars can be slipped onto the legs. The three legs fit with little play exactly into the hollow profiles of the bars. The legs and the hollow profiles can have a rectangular, square or circular cross section.

U.S. Pat. No. 5,485,705 to Guillernet discloses a corner assembly for holding a screen frame. The corner assembly has a pair of connector arms extending outwardly from a corner connector portion. The arms are telescopically received in the corner connector, generally at 90 degrees relative to each other. Each corner assembly includes a slide member carried in a slide way. The cross-sectional configuration for side members of the frame may be of the roll formed or extruded U-shaped construction. Each arm of the corner assembly has a U-shaped configuration, opening into a channel, adapted to be resiliently received in gripping telescopic relation within the side members.

The components in the above devices and their methods of use are different from the present invention, which is directed to the large frame silk screen process. Currently, silk screens use square or rectangular permanently welded metal frames, comprising four side members connected at right angles. Welding is necessary to give the frames the strength and resiliency necessary for the process. For large format silk screens, these frames are inconvenient, expensive, and occasionally impossible to ship from one location to another because of their size. In order to have large format silk screens in multiple locations, a company must either ship large metal frames, or have frames built at each location.

Therefore, it is an object of the present invention to provide a corner joint assembly for connecting large format silk screen frame side members to form a collapsible silk screen frame, which can be broken down into four side members and shipped at lower cost.

A further object is to provide a corner joint assembly for constructing a frame rigid enough to stretch material on, as is required during the silk screening process.

Finally, it is an object of the present invention to provide a corner joint assembly that speeds up the assembly process, increasing the strength of an assembled frame, and forms an air-tight seal to prevent any liquid used in the silk screening process from finding its way to the interior of the frame or corner assemblies. These and other objects of the present invention will become better understood with reference to the appended Summary, Description, and Claims.

### SUMMARY

The present invention comprises of a corner joint assembly for connecting side frame members of a silk screen frame. The assembly consists of two types of connectors; a male member and a female member. The male member comprises a connector segment to accommodate the end of a side member of the frame, and two body sections extending from the connector. The first body section comprises a member equal in circumference to the side member. The second body section comprises a smaller member. The body sections include holes for receiving bolts oriented parallel to the frame side member, to anchor the male member to a female member.

The female member comprises a connector segment to accommodate the end of a side member of the frame, and a body block extending from the connector. The body block comprises a member equal in circumference to the frame side member. Two opposing side surfaces of the body block include a slot adapted to receive the second body section of a male member, and holes extend between the slots to receive the bolt shanks.

To construct a silk screen frame, four side members; two capped with male members and two capped with female members are required. The second body section of a male member is inserted in one of the slots of a female member, with the bolts passing through the holes in the female member. A portion of the bolt shanks emerges into the opposing female member slot and nuts and washers are used to secure the members together. The slot in the female member is configured to fit securely around the second section of the male member, so that torque forces on the frame are absorbed by the members, rather than by the bolts.

### BRIEF DESCRIPTION OF THE FIGURES

FIGS. 1 and 2 are perspective views of the male member of the corner joint assembly of the present invention.

FIG. 3 and 4 are perspective views of the male member with bolts installed.

FIGS. 5 is a perspective view of the female member of the corner joint assembly.

FIG. 6 is a side view of the female member.

FIG. 7 is a plan view of the male member with the frame side member attached.

FIG. 8 is a plan view of the female member with the frame side member attached.

FIGS. 9 is a perspective view showing the assembly of the male and the female members.

FIG. 10 is a perspective view of one of the corners of the frame with the frame side members.

### FIGURES—REFERENCE NUMERALS

10 . . . Corner Joint Assembly
11 . . . Male Member
12 . . . Female Member
13 . . . Connector
14 . . . First Section
15 . . . Second Section
16 . . . Male Member Hole
17 . . . Hole Inner Opening
18 . . . Bolt
19 . . . Non-tapered Section
20 . . . First Tapered Section
21 . . . Second Tapered Section
22 . . . Female Member Block
23 . . . Slot
24 . . . Frame Side Member
25 . . . Female Member Hole
26 . . . Channel
27 . . . Nut
28 . . . Washer

### DETAILED DESCRIPTION

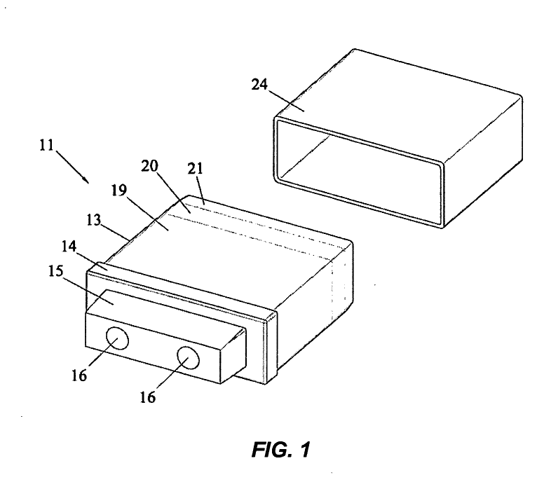

Referring to the drawings, a preferred embodiment of the corner joint assembly is illustrated and generally indicated as 10 in FIGS. 1 through 10. The corner joint assembly comprises a male member 11 and a female member 12.

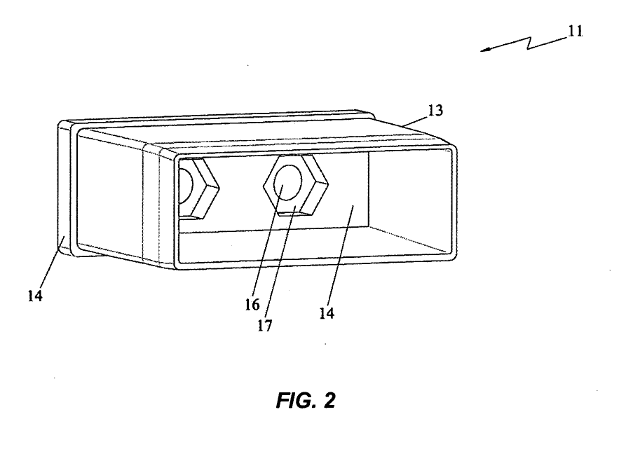

Referring to FIGS. 1 and 2, the male member 11 comprises a connector 13 and two sections, namely, a first section 14 and a second section 15. In a preferred embodiment, the connector 13, first section 14 and second section 15 are assembled from a single piece of material. The connector 13 comes into contact with the interior of a frame side member 24, and is tapered for easy insertion into the end of a frame side member 24. Specifically, the connector comprises a non-tapered section 19, a first tapered section 20, and a second tapered section 21. The non-tapered is shaped and dimensioned to fit inside the frame member. In a preferred embodiment, the first tapered section 20 is tapered at an angle of 3 degrees and the second tapered section 21 is tapered at an angle of 8 degrees. In other embodiments, the connector can be cylindrical or any other shape, depending on the shape of the frame side member, adapting the tapered configuration explained above.

The first section 14 of the male member 11 extends from the connector 13, so that when inserted, the first section 14 makes a uniform connection to the frame side member 24. The second section 15 extends from the opposite side of the first section 14. The second section 15 is smaller in circumference than the first section 14 and has a slight taper for easy connection to a female member.

The male member 11 also includes two holes 16 passing through the first section 14 and second section 15. The inner opening 17 of the holes 16 adjacent to the connector 13 is shaped to accommodate the head of a bolt and prevent it from turning. The portion of the holes 16 extending from the inner opening 17 to the end of the second section 15 accommodates the shanks of the bolts 17.

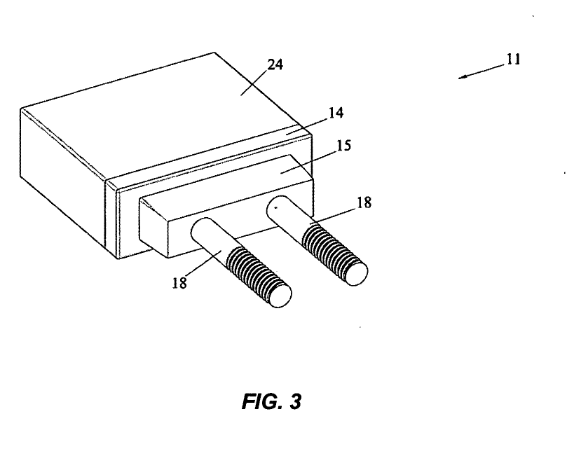

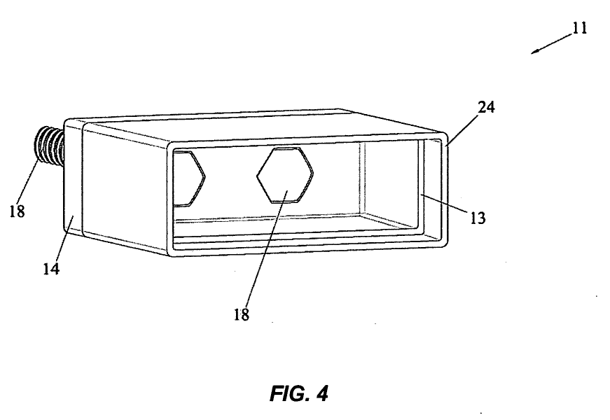

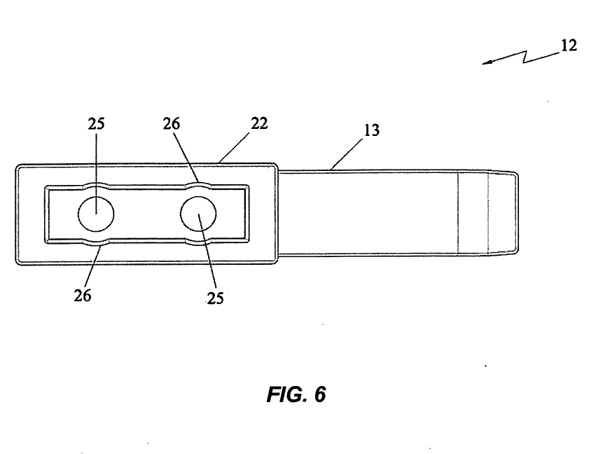

Referring to FIGS. 3 and 4, prior to connecting the male member 11 to a frame side member 24, bolts 18 are inserted into the holes 16 from inside the connector 13 and seated in place as shown in FIG. 6. Once fully inserted, the heads of the bolts 18 are hermetically sealed to anchor the bolts 18 in place and create a barrier between the bolts 18 and the interior of the connector 13.

Once the bolts 18 are anchored in place, the connector 13 is inserted into a frame side member 24 and sealed to anchor the male member 11 in place and create a permanent hermetic seal between the connector 13 and the frame side member 24. To create a hermetic seal, adhesive or glue such as resin is applied to the inside to the frame side member before inserting the connector 13. Once the male member 11 is sealed and anchored in place, it forms a uniform extension to the frame side member 24.

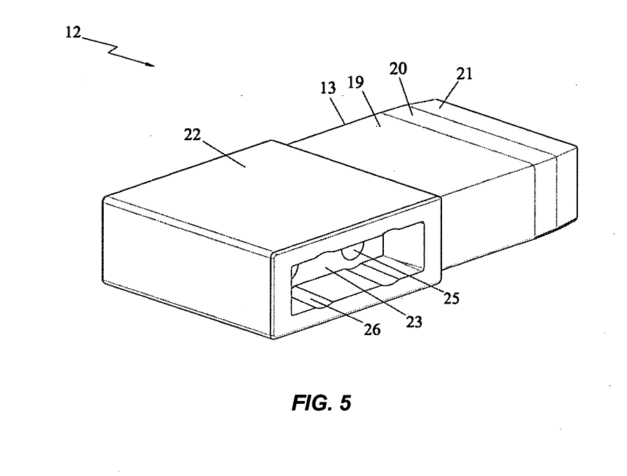

Referring to FIGS. 5 and 6, the female member 12 comprises a block 23 and a connector 13 to engage a frame side connector 24. The block 23 extends from the connector 13 so that when inserted, the block 23 makes a uniform connection to the frame side member 24. The connector 13 is tapered for easy insertion into the end of a frame side member 24. In a preferred embodiment, the connector 13 and block 23 are assembled from a single piece of material.

Two opposing sides of the block 23 include a slot 23. The slots 23 receive the second section 15 of a male member 11, so that when a second section 15 is inserted into a slot 23, rotational movement between the male member 11 and female member 12 is impossible. In a preferred embodiment, the opposing slots 23 are identical, so that the female member 12 is reversible, and either slot 23 can secure the male member 11.

The female member 12 also includes two parallel holes 25 extending connecting the slots 23. The holes 25 are adapted to receive the bolt 18 shanks. Channels 26 are disposed on the sides of the slots adjacent the holes 25. The channels 26 are designed to create space for an anchoring means to hold the bolts in place. In addition, the channels 26 also provide tool access for installing and removing the anchoring means. Resin is applied to the inside to the frame side member and the connector 13 of the female member 12 is inserted to anchor the female member 12 in place and create a permanent hermetic seal between the connector 13 and the frame side member 24.

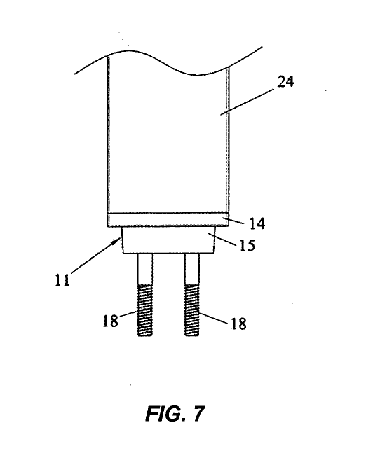

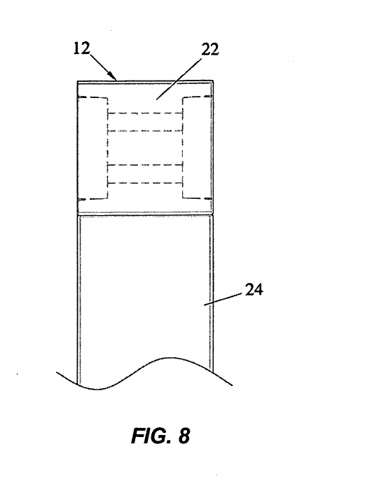

Referring to FIGS. 7 and 8, the male 11 and female 12 members are designed to cap the frame side members 24. In a preferred embodiment of the invention, disassembled frame comprises two frame side members 24 capped with male members 11, and two side frame members 24 capped with female members 12. The connected members create a resilient frame that resists torque forces and can be easily disassembled for transport.

In another preferred embodiment, the inner and outer surfaces of the connectors 13 are coated with adhesive. In the male member, the inner surface comprises of a contiguous layer of adhesive over the anchoring means. This process permanently secures the bolts 18 to the male member.

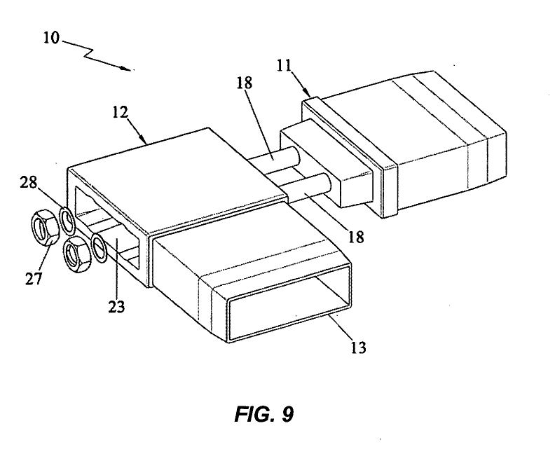

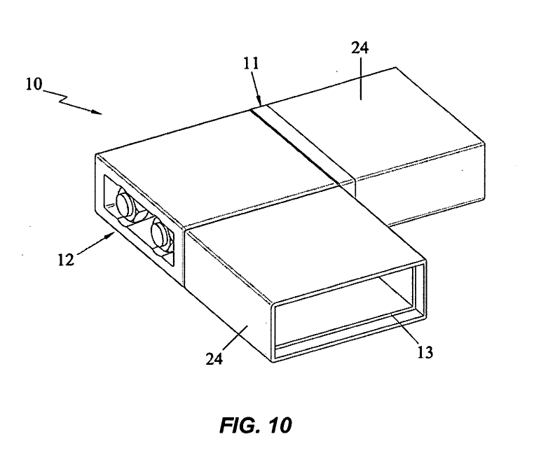

Referring to FIGS. 9 and 10, the method of connecting the male and female members is explained. The male member 11 with bolts 18 is positioned facing a slot 23 of the female member. The shank of the bolts 18 and the holes in the female member are aligned and the second section 15 of a male member is inserted in a slot 23. Part of the bolts 18 emerge from the opposing slot 23. In a preferred embodiment using bolts, nuts 27 and washers 28 are used to secure the male and female members.

The hermetic seal between the male and female members, and the side frame members; and the hermetic seal around the bolts prevents moisture from reaching the interior of the frame. Since re-emerging moisture from prior silk screen processes can harm subsequent silk screens, the male and female members not only ensure a perfectly square fit without concentrating stress entirely on the bolts, they also can be re-used without retaining moisture.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A corner joint assembly for connecting frame members in a perpendicular orientation, comprising:
(a) a male member comprising; a connector for receiving a frame member and a block extending from one side of the connector, the block comprising of a first section, and a second section extending from the first section, wherein the cross sectional area of the second section being smaller than the first section; and
(b) a female member comprising: a connector for receiving a frame member, and a block extending from one side of the connector, the block comprising of a receptacle for receiving the second section of the male member, and a fastening means for fastening the male and female members.

2. The corner joint assembly of claim 1, wherein the connectors comprise a non-tapered section in connection with the block of the male/female member, a first tapered section extending from the non-tapered section, and a second tapered section extending from the non-tapered section

3. The corner joint assembly of claim 2, wherein the non-tapered is shaped and dimensioned to fit inside the frame member.

4. The corner joint assembly of claim 2, wherein the taper angle of the second tapered section is more than the taper angle of the first tapered section.

5. The corner joint assembly of claim 4, wherein the first tapered section is tapered at an angle of 3 degrees and the second tapered section is tapered at an angle of 8 degrees.

6. The corner joint assembly of claim 2, wherein the connector comprises a means to prevent moisture from moving across the boundary of the frame member and the connector.

7. The corner joint assembly of claim 6, wherein the means for preventing moisture comprises a seal between the frame member and the connector.

8. The corner joint assembly of claim 7, wherein the seal is an adhesive.

9. The corner joint assembly of claim 8, wherein the adhesive is resin.

10. The corner joint assembly of claim 1, wherein the attachment means comprises at least one attachment member extending from the second section of the male member to the female member.

11. The corner joint assembly of claim 10, wherein the attachment means terminates on another side of the female member and is anchored by an anchoring means.

12. The corner joint assembly of claim 1, wherein the space in the female member for accommodating the second section of the male member, also accommodates the fastening means.

13. The corner joint assembly of claim 12, wherein the female member is reversible, with identical spaces.

14. The corner joint assembly of claim 1, wherein the at least one fastening means comprises a bolt.

15. The corner joint assembly of claim 14, wherein the head of a bolt fits in an indentation in the first section of the male member, opposite the second section of the male member, to provide resistance.

16. The corner joint assembly of claim 15, wherein the shape of the indentation corresponds to the shape of the head to prevent the bolt from rotating.

17. The corner assembly of claim 16, wherein the head of the bolt is held in the indentation by a sealing means that prevents moisture from moving through the male member.

18. The corner joint assembly of claim 1, wherein the female member comprises two opposing receptacles, each receptacle capable of receiving the second section of the male member and an attachment means.

19. The corner joint assembly of claim 18, wherein each receptacle is accommodates the second section of a male member, so that rotational movement of the male member is impossible.

20. The corner joint assembly of claim 1, wherein the second section of the male member is tapered for easy insertion into the female member.

21. The corner joint assembly of claim 1, wherein the depth of the receptacle of the female member is equal to the height of the second section of the male member.

22. The corner joint assembly of claim 1, wherein the receptacle of the female member includes a means for facilitating fastening of the attachment means.

23. The corner joint assembly of claim 20, wherein the facilitating means comprises means to accommodate a fastening means affixed to the attachment means.

24. The corner joint assembly of claim 19, wherein two attachment means and two fastening means are used.

25. The corner joint assembly of claim 1, wherein the corner joint assembly is comprised of aluminum.
